(19) United States
(12) Patent Application Publication
(10) Pub. No.: US 2026/0267194 A1
(43) Pub. Date: Sep. 10, 2026

(54) REFLECTIVE DISPLAY DEVICE

(71) Applicant: ELECTRONICS AND TELECOMMUNICATIONS RESEARCH INSTITUTE, Daejeon (KR)

(72) Inventors: Tae-Youb KIM, Daejeon (KR); JUHYUN PARK, Daejeon (KR); Juhee SONG, Daejeon (KR); Chil Seong AH, Daejeon (KR); Ji-Young OH, Daejeon (KR); Yongjun LEE, Daejeon (KR); Doo-Hee CHO, Daejeon (KR); Jisu HAN, Daejeon (KR)

(21) Appl. No.: 19/391,652

(22) Filed: Nov. 17, 2025

(30) Foreign Application Priority Data
Mar. 7, 2025 (KR) 10-2025-0030105

(51) Int. Cl. G02F 1/1676; G02F 1/167

(52) U.S. Cl. CPC G02F 1/1676; G02F 1/167; G02F 2203/02

(57) ABSTRACT

A reflective display device includes a lower electrode and an upper electrode, which are opposite to and spaced apart from each other, and a first solvent, a capsule structure, and infrared chromic particles, which are disposed between the lower electrode and the upper electrode. The capsule structure may include a capsule wall, a second solvent within the capsule wall, and first electrophoretic particles and second electrophoretic particles, which are dispersed in the second solvent and charged with different charges.

### CROSS-REFERENCE TO RELATED APPLICATION(S)

This U.S. non-provisional patent application claims priority under 35 U.S.C. § 119 of Korean Patent Application No. 10-2025-0030105, filed on Mar. 7, 2025, the entire contents of which are hereby incorporated by reference.

### BACKGROUND

### Field of the Invention

The present disclosure herein relates to a reflective display device, and more particularly, to a reflective display device capable of broadband expression.

### Description of Related Art

Electronic paper (e-paper), which is a type of reflective display, replaces typical paper used for a book, a newspaper, and a magazine. E-paper provides a high resolution and a wide viewing angle, like typical paper and ink, and displays an image even after power is cut off. In addition, since a part such as a backlight unit of a liquid crystal display (LCD) is unnecessary for e-paper, the service life of the battery is increased.

In an electrophoretic method that is a method of driving e-paper, an electric field is applied to a solution and particles having a color contrasting with that of the solution, and then, charged particles are moved upward or downward by electrophoresis, thereby displaying an image. E paper using the electrophoretic method includes electronic ink capsules to have high bistability, an excellent contrast ratio, excellent reflectivity, and low driving voltage. However, there is also a disadvantage in that its use is limited in infrared display elements.

Electrochromic elements have been developed with a focus on devices that utilize changes in transmittance/reflectivity in a visible light range, such as smart windows, but recently, the fields of application to devices that utilize changes in optical properties in an infrared range has been attracting attention. Thus, research is actively being conducted to combine electrophoretic and electrochromic elements.

### SUMMARY

The present disclosure provides a reflective display device capable of simultaneously expressing visible light and infrared rays.

The object of the present disclosure is not limited to the aforesaid, but other objects not described herein will be clearly understood by those skilled in the art from descriptions below.

An embodiment of the inventive concept provides a reflective display device including: a lower electrode and an upper electrode, which are opposite to and spaced apart from each other; and a first solvent, a capsule structure, and infrared chromic particles, which are disposed between the lower electrode and the upper electrode, wherein the capsule structure includes: a capsule wall; a second solvent within the capsule wall; and first electrophoretic particles and second electrophoretic particles, which are dispersed in the second solvent and charged with different charges.

In an embodiment, the capsule structure and the infrared chromic particles may be dispersed in the first solvent.

In an embodiment, the capsule wall may be configured to separate the electrophoretic particles and the infrared chromic particles from each other.

In an embodiment, the first solvent may include at least one of polyacrylonitrile (PAN), polyvinyl alcohol (PVA), polymethyl methacrylate (PMMA), polyurethane (PU), or a combination thereof.

In an embodiment, the first solvent may further include an additive, wherein the additive may include at least one of LiClO₄, LiBF₄, LiPF₆, SiO₂, or a combination thereof.

In an embodiment, the capsule structure may be dispersed in the first solvent, and the infrared chromic particles may be disposed within the capsule structure.

In an embodiment, the capsule structure may further include the infrared chromic particles, wherein the infrared chromic particles may be dispersed in the second solvent.

In an embodiment, the second solvent may include at least one of 1-ethyl-3-methylimidazolium (EMLm-X), polyvinyl alcohol (PVA), silicone oil, or a combination thereof.

In an embodiment, the second solvent may further include at least one of LiClO₄, LiBF₄, LiPF₆, SiO₂, or a combination thereof.

In an embodiment, at least one of the lower electrode and the upper electrode may be configured to transmit visible light and infrared rays.

In an embodiment of the inventive concept, a reflective display device includes: a lower electrode and an upper electrode, which are opposite to and spaced apart from each other; a first solvent between the lower electrode and the upper electrode; and a capsule structure dispersed in the first solvent, wherein the capsule structure includes: a capsule wall; a second solvent within the capsule wall; and first display particles and second display particles, which are dispersed in the second solvent, wherein each of the first display particles includes first electrophoretic particles and a first infrared chromic layer that surrounds the first electrophoretic particles, and each of the second display particles includes second electrophoretic particles and a second infrared chromic layer that surrounds the second electrophoretic particles, wherein the first electrophoretic particles and the second electrophoretic particles are charged with different charges.

In an embodiment, each of the first infrared chromic layer and the second infrared chromic layer may be coated with a substantially uniform thickness.

In an embodiment, the first electrophoretic particles and the second electrophoretic particles may be configured to reflect visible light having different wavelengths.

In an embodiment, the first infrared chromic layer may include the same material as the second infrared chromic layer, wherein a thickness of the second infrared chromic layer may be thicker than a thickness of the first infrared chromic layer.

In an embodiment, the thickness of the second infrared chromic layer may be about 1 time to about 1.5 times greater than the thickness of the first infrared chromic layer.

In an embodiment, the first infrared chromic layer may have substantially the same thickness as the second infrared chromic layer, wherein infrared emissivity of the second infrared chromic layer may be greater than infrared emissivity of the first infrared chromic layer.

In an embodiment, each of the first and second infrared chromic layers may be configured to transmit visible light.

In an embodiment, each of the first and second infrared chromic layers may include at least one of tungsten oxide (WO₃), nickel oxide (NiO), vanadium oxide (V₂O₅), iridium oxide (IrO₂), polyaniline (PANI), a conductive polymer, or a combination thereof.

In an embodiment, at least one of the lower electrode and the upper electrode may be configured to transmit visible light and infrared rays.

In an embodiment of the inventive concept, a reflective display device includes: a first substrate and a second substrate, which are opposite to and spaced apart from each other; a first pixel configured to reflect infrared rays and a second pixel configured to reflect visible light between the first substrate and the second substrate; and a pixel defining layer configured to separate the first pixel and the second pixel from each other, wherein the first pixel includes: a first lower electrode and a first upper electrode, which are opposite to and spaced apart from each other; an electrolyte between the first lower electrode and the first upper electrode; and infrared chromic particles dispersed in the electrolyte, and the second pixel includes: a second lower electrode and a second upper electrode, which are opposite to and spaced apart from each other; a first solvent between the second lower electrode and the second upper electrode; and a capsule structure dispersed in the first solvent, wherein the capsule structure includes: a capsule wall; a second solvent within the capsule wall; and first electrophoretic particles and second electrophoretic particles, which are dispersed in the second solvent and charged with different charges.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view for explaining a reflective display device according to embodiments of the inventive concept;

FIG. 2 is a cross-sectional view corresponding to line A-A’ of FIG. 1 as a view for explaining the reflective display device according to embodiments of the inventive concept;

FIG. 3 is a cross-sectional view corresponding to line A-A’ of FIG. 1 as a view for explaining a reflective display device according to another embodiment of the inventive concept;

FIG. 4 is a cross-sectional view corresponding to A-A’ of FIG. 1 as a view for explaining a reflective display device according to further another embodiment of the inventive concept;

FIG. 5 is a cross-sectional view corresponding to A-A’ of FIG. 1 as a view for explaining a reflective display device according to further another embodiment of the inventive concept;

FIG. 6 is a cross-sectional view corresponding to line A-A’ of FIG. 1 as a view for explaining a reflective display device according to further another embodiment of the inventive concept;

FIG. 7 is an enlarged view corresponding to reference symbols DP1 and DP2 of FIG. 6 as a view for explaining display particles according to an embodiment of the inventive concept;

FIG. 8 is an enlarged view corresponding to reference symbols DP1 and DP2 of FIG. 6 as a view for explaining display particles according to another embodiment of the inventive concept; and

FIGS. 9 and 10 are photographs for explaining an effect of the reflective display device according to embodiments of the inventive concept.

### DETAILED DESCRIPTION

In order to sufficiently understand the configuration and effect of the present invention, some embodiments of the present invention will be described with reference to the accompanying drawings. The present disclosure may, however, be embodied in different forms and should not be construed as limited to the embodiments set forth herein. Rather, the exemplary embodiments are provided only to disclose the present invention and let those skilled in the art fully know the scope of the present invention. In the accompanying drawings, the components are shown enlarged for the sake of convenience of explanation, and the proportions of the components may be exaggerated or reduced for clarity of illustration.

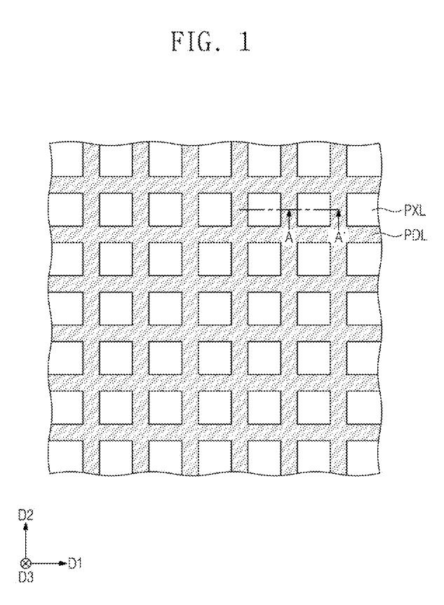

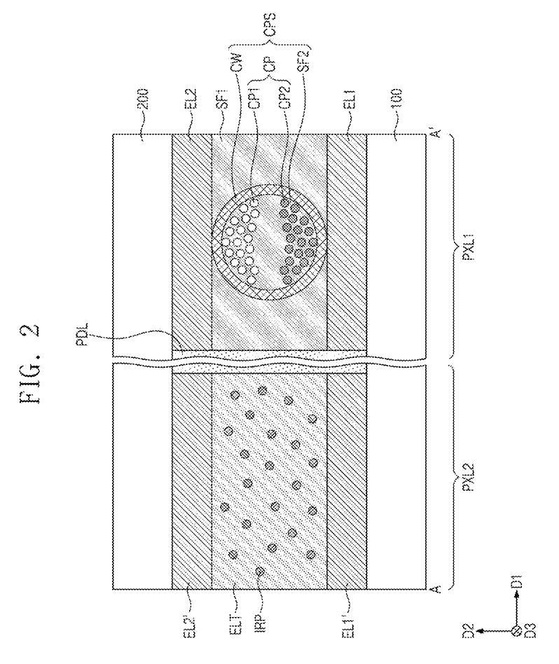

FIG. 1 is a plan view for explaining a reflective display device according to embodiments of the inventive concept. FIG. 2 is a cross-sectional view corresponding to line A-A’ of FIG. 1 as a view for explaining the reflective display device according to embodiments of the inventive concept.

Referring to FIG. 1, a reflective display device according to the inventive concept may include pixels PXL and a pixel defining layer PDL.

Each of the pixels PXL may reflect light incident from the outside to provide light having a specific color. The reflective display device including the pixels PXL may provide light having various wavelengths. For example, each of the

pixels PXL may provide light having a red color, a green color, a blue color, or a combination thereof. For example, each pixel PXL may provide infrared rays having a different wavelength.

In this specification, a first direction D1 may mean a direction parallel to a top surface of a first substrate 100, a second direction D2 may mean a direction parallel to the top surface of the first substrate 100 and intersecting the first direction D1, and a third direction D3 may mean a direction perpendicular to the top surface of the first substrate 100. That is, the third direction D3 may mean a direction that is perpendicular to the first direction D1 and the second direction D2.

The specific configuration of each pixel PXL and the pixel defining layer PDL will be described later.

Referring to FIGS. 1 and 2, the pixels PXL may include a first pixel PXL1 and a second pixel PXL2. For example, the first pixel PXL1 may correspond to an electrophoretic display EPD, and the second pixel PXL2 may correspond to an electrochromic display ECD. In other words, the pixels PXL may include a structure in which the electrophoretic display EPD and the electrochromic display ECD are alternately disposed.

The first pixel PXL1 may include the first substrate 100, a second substrate 200, a first lower electrode EL1, a first upper electrode EL2, a first solvent SF1, and a capsule structure CPS.

The pixels PXL may include the first substrate 100 and the second substrate 200 that are opposite to each other and spaced apart from each other in the second direction D2. Each pixel PXL may share the first substrate 100 and the second substrate 200. For example, the first pixel PXL1 and the second pixel PXL2 may share the first substrate 100 and the second substrate 200, but the embodiment of the inventive concept is not limited thereto.

Each of the first substrate 100 and the second substrate 200 may include a transparent substrate. At least one of the first substrate 100 or the second substrate 200 may be transparent to both infrared rays and visible light. In other words, at least one of the first substrate 100 or the second substrate 200 may transmit both the infrared rays and the visible light. For example, each of the first substrate 100 and the second substrate 200 may include at least one of glass, polyimide (PI), polycarbonate (PC), and indium-tin-oxide (ITO).

The first lower electrode EL1 of the first pixel PXL1 may be provided on a top surface of the first substrate 100, and the first upper electrode EL2 of the first pixel PXL1 may be provided on a bottom surface of the second substrate 200. The first lower electrode EL1 may be in contact with the top surface of the first substrate 100, and the first upper electrode EL2 may be in contact with the bottom surface of the second substrate 200.

The first lower electrode EL1 and the first upper electrode EL2 may be spaced apart from each other in the third direction D3.

The first lower electrode EL1 and the first upper electrode EL2 may be independently controlled.

Each of the first lower electrode EL1 and the first upper electrode EL2 may include a transparent electrode. Each of the first lower electrode EL1 and the first upper electrode EL2 may be transparent to both the infrared rays and the visible light. In other words, each of the first lower electrode EL1 and the first upper electrode EL2 may transmit both the infrared rays and the visible light. For example, each of the first lower electrode EL1 and the first upper electrode EL2 may include at least one of indium-tin-oxide (ITO), fluorine doped tin dioxide (FTO), aluminum-doped zinc oxide (AZO), gallium-doped zinc oxide (GZO), graphene, silver nanowires, carbon nanotube (CNT), or poly(3,4-ethylenedioxythiophene):poly(styrenesulfonate) (PEDOT:PSS).

The first solvent SF1 may be provided between the first lower electrode EL1 and the first upper electrode EL2.

The first solvent SF1 may be filled into a region surrounded by the first lower electrode EL1, the first upper electrode EL2, and the pixel defining layer PDL. For example, the first solvent SF1 may include at least one of polyacrylonitrile (PAN), polyvinyl alcohol (PVA), polymethyl methacrylate (PMMA), polyurethane (PU), or a combination thereof.

The capsule structure CPS may be provided to be dispersed in the first solvent SF1. The capsule structure CPS may include a second solvent SF2, electrophoretic particles CP, and a capsule wall CW.

The capsule structure CPS as a whole may serve a function of providing light having a specific color.

The capsule wall CW may serve to separate the inside and outside of a capsule from each other. For example, the capsule wall may include at least one of polyurethane (PU), polymethyl methacrylate (PMMA), polystyrene, polyimide (PI), silicon oxide, or titanium oxide.

The second solvent SF2 may be filled into the inside of the capsule wall CW. For example, the second solvent SF2 may include at least one of hexane, octane, silicone oil, isoparaffin, or a combination thereof.

Although not shown, the second solvent SF2 may further include a blending agent (or stabilizer). For example, the blending agent (or stabilizer) may include at least one of a surfactant, a dispersant, or a combination thereof.

The electrophoretic particles CP may be provided to be dispersed in the second solvent SF2. The electrophoretic particles CP may include first electrophoretic particles CP1 and second electrophoretic particles CP2, which are charged with different charges. For example, the first electrophoretic particles CP1 may be charged with a positive (+) charge, and the second electrophoretic particles CP2 may be charged with a negative (-) charge.

The first electrophoretic particles CP1 may have a color different from that of the second electrophoretic particles CP2. For example, the first electrophoretic particles CP1 may have a white color, and the second electrophoretic particles CP2 may have a black color.

The first pixel PXL1 may control voltages of the first lower electrode EL1 and the first upper electrode EL2 to adjust positions of the first and second electrophoretic particles CP1 and CP2, thereby displaying light having a specific color. In other words, the first pixel PXL1 may function as the electrophoretic display EPD that displays a visible light band.

For example, each of the first and second electrophoretic particles CP1 and CP2 may include at least one of organic pigments, inorganic pigments (e.g., TiO₂, Fe₂O₃, Cr₂O₃, etc.), dye-based particles (e.g., dye-adsorbed silicon oxide, dye-doped polystyrene, etc.), gold nanoparticles, or quantum dots.

Unlike those illustrated, in embodiments according to the inventive concept, the electrophoretic particles CP may further include electrophoretic particles charged with another charge and may include three or more different types of electrophoretic particles, and the three or more different types of electrophoretic particles may have different colors.

The pixel defining layer PDL defining each pixel PXL may be provided. The pixel defining layer PDL may separate and distinguish the pixels PXL from each other in the first direction D1 or the second direction D2. For example, the pixel defining layer PDL may separate the first pixel PXL1 and the second pixel PXL2 from each other so that the first pixel PXL1 and the second pixel PXL2 are spaced apart from each other in the first direction D1. For example, the pixel defining layer PDL may have a lattice structure or a grid structure.

The pixel defining layer PDL may include an organic insulating material. For example, the pixel defining layer PDL may include at least one of polystyrene, polymethylmethacrylate (PMMA), polyacrylonitrile (PAN), polyamide (PA), polyimide (PI), polyarylether (PAE), heterocyclic polymer, parylene, epoxy, benzocyclobutene (BCB), siloxane-based resin, or silane-based resin.

The second pixel PXL2 may include a first substrate 100, a second substrate 200, a second lower electrode EL1', a second upper electrode EL2', an electrolyte ELT, and infrared chromic particles IRP.

The second lower electrode EL1' of the second pixel PXL2 may be provided on a top surface of the first substrate 100, and the second upper electrode EL2' of the second pixel PXL2 may be provided on a bottom surface of the second substrate 200. The second lower electrode EL1' may be in contact with the top surface of the first substrate 100, and the second upper electrode EL2' may be in contact with the bottom surface of the second substrate 200.

The second lower electrode EL1' and the second upper electrode EL2' may be spaced apart from each other in the third direction D3.

The second lower electrode EL1' may be spaced apart from the first lower electrode EL1 in the first direction D1 by the pixel defining layer PDL, and the second upper electrode EL2' may be spaced apart from the first upper electrode EL2 in the first direction D1 by the pixel defining layer PDL.

The second lower electrode EL1' and the second upper electrode EL2' may be independently controlled. That is, each of the first and second lower electrodes EL1 and EL1' and the first and second upper electrodes EL2 and EL2' may be independently controlled.

Each of the second lower electrode EL1' and the second upper electrode EL2' may include a transparent electrode. The second lower electrode EL1' and the second upper electrode EL2' may be transparent to both the infrared rays and the visible light. In other words, the second lower electrode EL1' and the second upper electrode EL2' may transmit both the infrared rays and the visible light. For example, the second lower electrode EL1' and the second upper electrode EL2' may include at least one of indium-tin-oxide (ITO), fluorine doped tin dioxide (FTO), aluminum-doped zinc oxide (AZO), gallium-doped zinc oxide (GZO), graphene, silver nanowires, carbon nanotube (CNT), or poly(3,4-ethylenedioxythiophene):poly(styrenesulfonate) (PEDOT:PSS).

The electrolyte ELT and the infrared chromic particles IRP may be provided between the second lower electrode EL1' and the second upper electrode EL2' of the second pixel PXL2.

The electrolyte ELT may be filled into a region surrounded by the second lower electrode EL1', the second upper electrode EL2', and the pixel defining layer PDL.

The electrolyte ELT may include a solvent and an additive. For example, the solvent included in the electrolyte ELT may include at least one of polyacrylonitrile (PAN), polyvinyl alcohol (PVA), polymethyl methacrylate (PMMA), polyurethane (PU), or a combination thereof. For example, the additive included in the electrolyte ELT may include at least one of LiClO₄, LiBF₄, LiPF₆, SiO₂, or a combination thereof.

The infrared chromic particles IRP may be provided to be dispersed in the electrolyte ELT. The infrared photochromic particles IRP may include a material that absorbs or reflects light having a specific wavelength through an oxidation/reduction reaction at a specific voltage. For example, the infrared chromic particles IRP may include at least one of tungsten oxide (WO₃), nickel oxide (NiO), vanadium oxide (V₂O₅), iridium oxide (IrO₂), polyaniline (PANI), a conductive polymer, or a combination thereof.

The second pixel PXL2 may control voltages of the second lower electrode EL1' and the second upper electrode EL2’ to adjust a degree of the oxidation/reduction of the infrared chromic particles IRP, thereby displaying infrared rays by absorbing or reflecting the infrared rays having a specific wavelength. In other words, the second pixel PXL2 may function as the electrochromic display ECD that displays an infrared band. That is, the reflective display device according to the inventive concept may simultaneously display the visible light and the infrared rays by simultaneously including the first pixel PXL1 that displays the visible light band and the second pixel PXL2 that displays the infrared band.

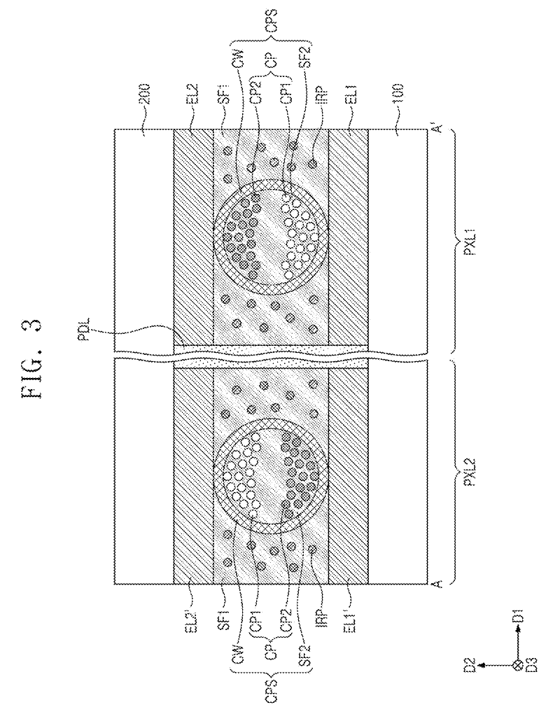

FIG. 3 is a cross-sectional view corresponding to line A-A’ of FIG. 1 as a view for explaining a reflective display device according to another embodiment of the inventive concept; However, differences from the reflective display device according to the foregoing embodiment of the inventive concept will be mainly described. For the sake of brevity, specific descriptions of configurations that are identical/similar to those described above may be omitted.

Referring to FIGS. 1 and 3, unlike the foregoing embodiment, the first pixel PXL1 may include a first substrate 100, a second substrate 200, a first lower electrode EL1, a first upper electrode EL2, a first solvent SF1, infrared chromic particles IRP, and a capsule structure CPS, and the second pixel PXL2 may also include a first substrate 100, a second substrate 200, a second lower electrode EL1', a second upper electrode EL2', a first solvent SF1, infrared chromic particles IRP, and a capsule structure CPS. In other words, the pixels PXL including the first pixel PXL1 and the second pixel PXL2 may have substantially the same structure.

Unlike the foregoing embodiment, the infrared chromic particles IRP and the capsule structure CPS may be dispersed together in the first solvent SF1.

The infrared chromic particles IRP may be disposed outside the capsule structure CPS. In other words, the capsule wall CW may separate the electrophoretic particles CP inside the capsule structure CPS from the infrared chromic particles IRP outside the capsule structure CPS.

Unlike the foregoing embodiment, the first solvent SF1 may further include an additive. For example, the additive may include at least one of LiClO₄, LiBF₄, LiPF₆, SiO₂, or a combination thereof.

Each pixel PXL may control voltages of the first and second lower electrodes EL1 and EL1' and the first and second upper electrodes EL2 and EL2' to control a degree of oxidation/reduction of the infrared chromic particles IRP and at the same time adjust positions of the electrophoretic particles CP. As a result, the infrared chromic particles IRPs may be controlled to absorb or reflect the infrared rays having a specific wavelength, and simultaneously, the capsule structure CPS may be controlled to display light having a specific color so that each pixel PXL displays both the visible light and infrared rays. In other words, electrochromic and electrophoretic characteristics may be simultaneously imparted to each pixel PXL, and thus, the reflective display device according to the inventive concept may display both the visible light band and the infrared band.

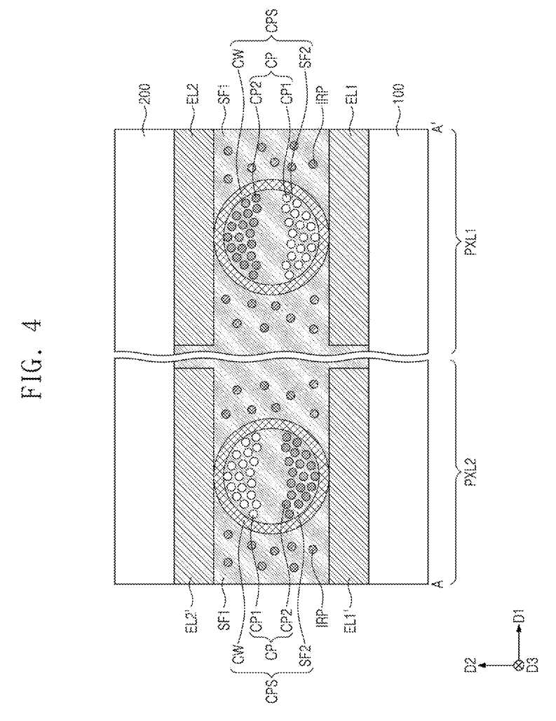

FIG. 4 is a cross-sectional view corresponding to A-A’ of FIG. 1 as a view for explaining a reflective display device according to further another embodiment of the inventive concept. However, differences from the reflective display device according to the foregoing embodiment of the inventive concept will be mainly described. For the sake of brevity, specific descriptions of configurations that are identical/similar to those described above may be omitted.

Referring to FIGS. 1 and 4, unlike the embodiment described with reference to FIG. 3, the pixel defining layer PDL may be omitted. The first solvent SF1 may replace the role of the pixel defining layer PDL.

The first solvent SF1 may cover the first and second lower electrodes EL1 and EL1' and the first and the second upper electrodes EL2 and EL2' between the first substrate 100 and the second substrate 200. The first solvent SF1 may separate the first and second lower electrodes EL1 and EL1' and the first and second upper electrodes EL2 and EL2' from each other in the third direction D3 and may separate the first lower electrode EL1 and the second lower electrode EL1' and the first upper electrode EL2 and the second upper electrode EL2' from each other in the first direction D1. In other words, the first solvent SF1 may serve to distinguish the pixels PXL from each other.

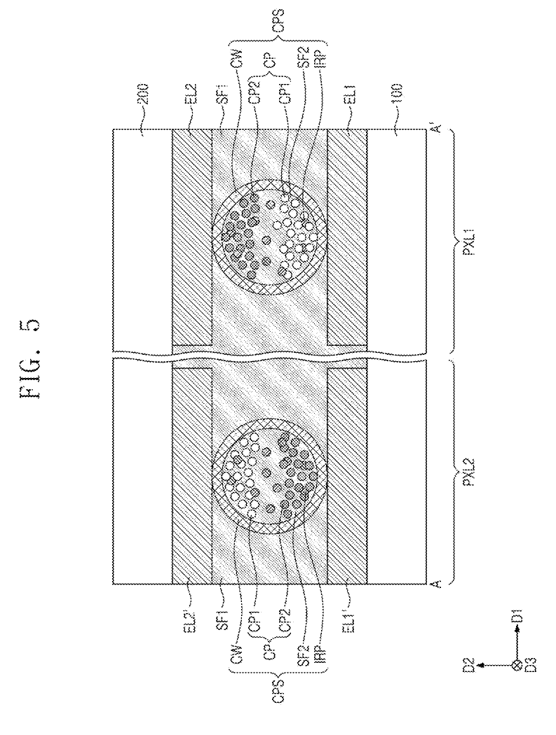

FIG. 5 is a cross-sectional view corresponding to A-A’ of FIG. 1 as a view for explaining a reflective display device according to further another embodiment of the inventive concept. However, differences from the reflective display device according to the foregoing embodiment of the inventive concept will be mainly described. For the sake of brevity, specific descriptions of configurations that are identical/similar to those described above may be omitted.

Referring to FIGS. 1 and 5, unlike the embodiment described with reference to FIG. 4, the infrared chromic particles IRP may be disposed inside the capsule structure CPS. In other words, the infrared chromic particles IRP may be dispersed in the second solvent SF2 together with electrophoretic particles CP.

Unlike the foregoing embodiment, the second solvent SF2 may include at least one of, for example, 1-ethyl-3-methylimidazolium (EMLm-X), polyvinyl alcohol (PVA), silicone oil, or a combination thereof.

Unlike the foregoing embodiment, the first solvent SF1 may not include an additive, and the second solvent SF2 may further include an additive. For example, the additive may include at least one of LiClO₄, LiBF₄, LiPF₆, SiO₂, or a combination thereof.

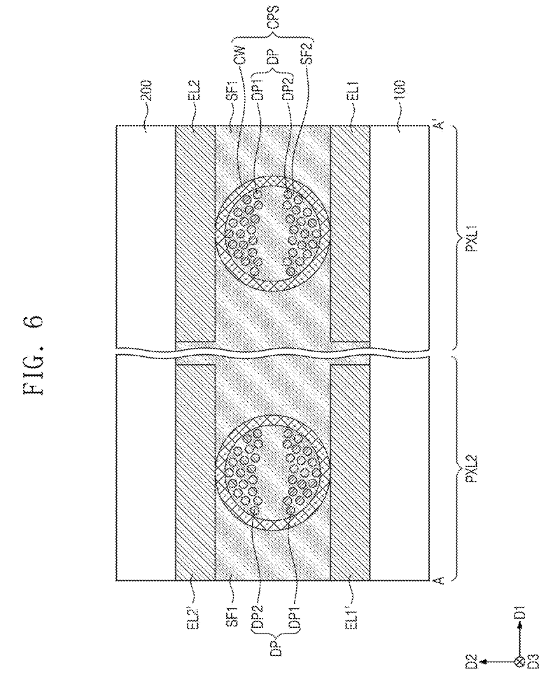

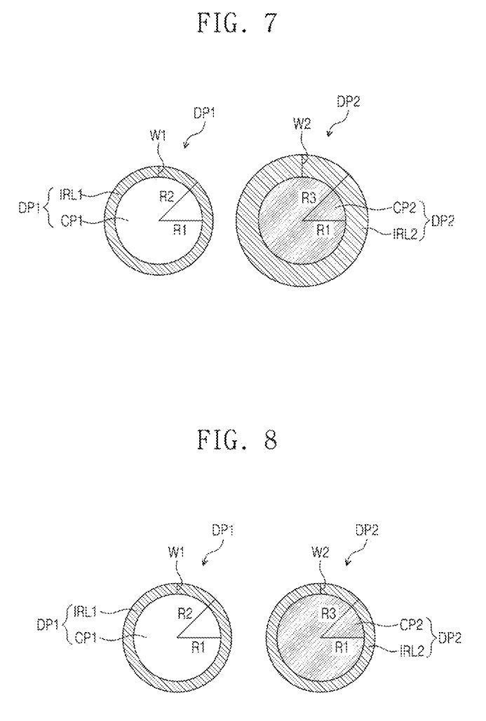

FIG. 6 is a cross-sectional view corresponding to line A-A’ of FIG. 1 as a view for explaining a reflective display device according to further another embodiment of the inventive concept; FIG. 7 is an enlarged view corresponding to reference symbols DP1 and DP2 of FIG. 6 as a view for explaining display particles according to an embodiment of the inventive concept; However, differences from the reflective display device according to the foregoing embodiment of the inventive concept will be mainly described. For the sake of brevity, specific descriptions of configurations that are identical/similar to those described above may be omitted.

Referring to FIGS. 6 and 7, unlike the embodiment described with reference to FIG. 5, the capsule structure CPS may include a capsule wall CW, a second solvent SF2, and display particles DP, and the display particles DP may include first display particles DP1 and second display particles DP2.

The first and second display particles DP may be provided to be dispersed in the second solvent SF2 within the capsule structure CPS.

The first display particles DP1 may include first electrophoretic particles CP1 and a first infrared chromic layer IRL1 surrounding each of the first electrophoretic particles CP1.

The first infrared chromic layer IRL1 may be provided by being coated with a uniform thickness on a surface of each of the first electrophoretic particles CP1.

The first infrared chromic layer IRL1 may include a material that absorbs or reflects infrared rays having a specific wavelength through an oxidation/reduction reaction at a specific voltage. For example, the first infrared chromic layer IRL1 may include at least one of tungsten oxide (WO₃), nickel oxide (NiO), vanadium oxide (V₂O₅), iridium oxide (IrO₂), polyaniline (PANI), a conductive polymer, or a combination thereof.

The second display particles DP2 may include second electrophoretic particles CP2 and a second infrared chromic layer IRL2 surrounding the second electrophoretic particles CP2.

The second infrared chromic layer IRL2 may be provided by being coated with a uniform thickness on a surface of each of the second electrophoretic particles CP2.

The first and second electrophoretic particles CP1 and CP2 may be charged with different charges and may absorb or reflect visible light having different wavelengths.

The second infrared chromic layer IRL2 may include a material that absorbs or reflects infrared rays having a specific wavelength through an oxidation/reduction reaction at a specific voltage. The second infrared chromic layer IRL2 may include the same material as the first infrared chromic layer IRL1. For example, the second infrared chromic layer IRL2 may include at least one of tungsten oxide (WO₃), nickel oxide (NiO), vanadium oxide (V₂O₅), iridium oxide (IrO₂), polyaniline (PANI), a conductive polymer, or a combination thereof.

The first infrared chromic layer IRL1 applied on the surface of each of the first electrophoretic particles CP1 may have a first thickness W1, and the second infrared chromic layer IRL2 applied on the surface of each of the second electrophoretic particles CP2 may have a second thickness W2.

The second thickness W2 of the second infrared chromic layer IRL2 may be thicker than the first thickness W1 of the first infrared chromic layer IRL1. For example, the second thickness W2 of the second infrared chromic layer IRL2 may be about 1 time to about 1.5 times the thickness of the first infrared chromic layer IRL1.

The first infrared chromic layer IRL1 and the second infrared chromic layer IRL2 may include the same material, but have different thicknesses, so that infrared reflectivity (or infrared emissivity) of the first display particles DP1 and the second display particles DP2 are different from each other. In other words, each pixel PXL may include display particles DP with different infrared reflectivities (or infrared emissivities) to express brightness/darkness of the infrared rays.

Unlike those illustrated, in embodiments according to the inventive concept, the display particles DP may further include electrophoretic particles charged with another charge and infrared chromic layers coated with another thickness and may include three or more different types of display particles, and the three or more different types of display particles may have different colors and infrared reflectivities (or infrared emissivities).

The first infrared chromic layer IRL1 may absorb or reflect infrared rays having a specific wavelength depending on voltages of the first lower electrode EL1 and the first upper electrode EL2 to display the infrared rays, and the second infrared chromic layer IRL2 may absorb or reflect infrared rays having a specific wavelength depending on voltages of the second lower electrode EL1' and the second upper electrode EL2’ to display the infrared rays. In other words, the first and second display particles DP1 and DP2 may include a first infrared chromic layer IRL1 and a second infrared chromic layer IRL2, respectively, to display the infrared rays.

The display particles DP may include first and second electrophoretic particles CP1 and CP2 to display a visible light band and may include first and second infrared chromic layers IRL1 and IRL2 to display an infrared band. Thus, each pixel PXL including the display particles DP may simultaneously display the visible light band and the infrared band.

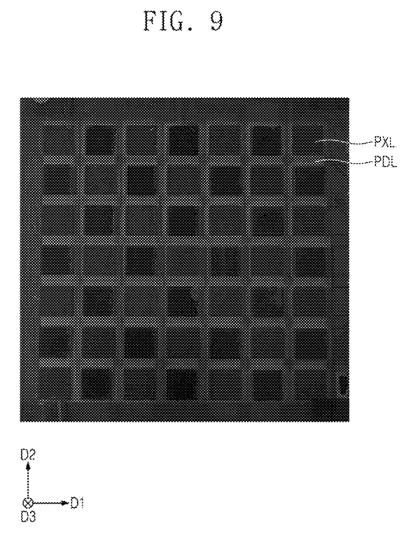

FIG. 8 is an enlarged view corresponding to reference symbols DP1 and DP2 of FIG. 6 as a view for explaining display particles according to another embodiment of the inventive concept. However, differences from the display particles according to the foregoing embodiments of the inventive concept will be mainly described. For the sake of brevity, specific descriptions of configurations that are identical/similar to those described above may be omitted.

Referring to FIGS. 6 and 8, unlike the embodiment described with reference to FIG. 7, the second infrared chromic layer IRL2 may include a material different from that of the first infrared chromic layer IRL1. The first infrared chromic layer IRL1 may include a material having different infrared reflectivity (or infrared emissivity) than that of the second infrared chromic layer IRL2. For example, the second infrared chromic layer IRL2 may include a material having higher infrared reflectivity (or infrared emissivity) than that of the first infrared chromic layer IRL1, and thus, the emissivity of the infrared rays of the second infrared chromic layer IRL2 may be greater than that of the infrared rays of the first infrared chromic layer IRL1.

Unlike the foregoing embodiment, the first infrared chromic layer IRL1 may have substantially the same thickness as the second infrared chromic layer IRL2. In other words, the first thickness W1 may be substantially equal to the second thickness W2.

That is, the first infrared chromic layer IRL1 and the second infrared chromic layer IRL2 may have substantially the same thickness, but include different materials, so that the infrared reflectivity (or infrared emissivity) of the first display particles DP1 and the second display particles DP2 are different from each other. In other words, each pixel PXL may include display particles DP with different infrared reflectivities (or infrared emissivities) to express brightness/darkness of the infrared rays.

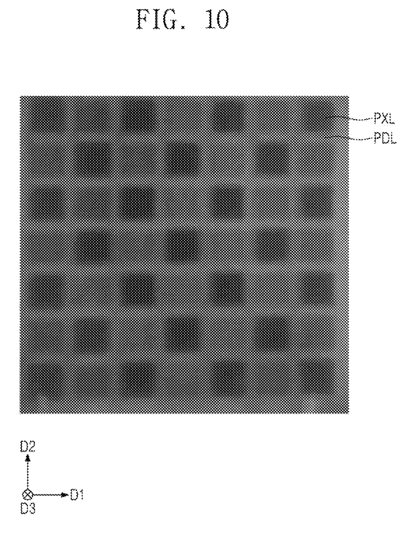

FIGS. 9 and 10 are photographs for explaining an effect of the reflective display device according to embodiments of the inventive concept. More specifically, FIG. 9 is a photograph illustrating a visible light display effect of the reflective display device according to embodiments of the inventive concept, and FIG. 10 is a photograph illustrating an infrared display effect of the reflective display device according to embodiments of the inventive concept.

Referring to FIGS. 9 and 10, it may be confirmed that the reflective display device according to embodiments of the inventive concept may simultaneously display the visible light and the infrared rays.

In the optical array device according to the inventive concept, the capsule structure including the plurality of electrophoretic particles may be disposed between the pair of opposing transparent electrodes to express the visible light, and at the same time, the infrared chromic materials that absorb and radiate the infrared rays may be disposed between the transparent electrodes to express the infrared rays. Therefore, the reflective display device according to the inventive concept may simultaneously express the visible light and the infrared rays.

The effects of the present invention are not limited to the aforementioned technical objects and unmentioned technical effects will be clearly understood by those skilled in the art from the specification and the appended claims.

Although the embodiment of the inventive concept is described with reference to the accompanying drawings, those with ordinary skill in the technical field of the inventive concept pertains will be understood that the present disclosure can be carried out in other specific forms without changing the technical idea or essential features. Therefore, the above-disclosed embodiments are to be considered illustrative and not restrictive.

What is claimed is:

1. A reflective display device comprising:
a lower electrode and an upper electrode, which are opposite to and spaced apart from each other; and
a first solvent, a capsule structure, and infrared chromic particles, which are disposed between the lower electrode and the upper electrode,
wherein the capsule structure comprises:
a capsule wall;
a second solvent within the capsule wall; and
first electrophoretic particles and second electrophoretic particles,
which are dispersed in the second solvent and charged with different charges.

2. The reflective display device of claim 1, wherein the capsule structure and the infrared chromic particles are dispersed in the first solvent.

3. The reflective display device of claim 1, wherein the capsule wall is configured to separate the electrophoretic particles and the infrared chromic particles from each other.

4. The reflective display device of claim 1, wherein the first solvent comprises at least one of polyacrylonitrile (PAN), polyvinyl alcohol (PVA), polymethyl methacrylate (PMMA), polyurethane (PU), or a combination thereof.

5. The reflective display device of claim 4, wherein the first solvent further comprises an additive,
wherein the additive comprises at least one of LiClO₄ LiBF₄ LiPF₆ SiO₂ or a combination thereof.

6. The reflective display device of claim 1, wherein the capsule structure is dispersed in the first solvent, and
the infrared chromic particles are disposed within the capsule structure.

7. The reflective display device of claim 1, wherein the capsule structure further comprises the infrared chromic particles,
wherein the infrared chromic particles are dispersed in the second solvent.

8. The reflective display device of claim 7, wherein the second solvent comprises at least one of 1-ethyl-3-methylimidazolium (EMLm-X), polyvinyl alcohol (PVA), silicone oil, or a combination thereof.

9. The reflective display device of claim 8, wherein the second solvent further comprises at least one of LiClO₄ LiBF₄ LiPF₆ SiO₂ or a combination thereof.

10. The reflective display device of claim 1, wherein at least one of the lower electrode and the upper electrode is configured to transmit visible light and infrared rays.

11. A reflective display device comprising:
a lower electrode and an upper electrode, which are opposite to and spaced apart from each other;
a first solvent between the lower electrode and the upper electrode; and
a capsule structure dispersed in the first solvent,
wherein the capsule structure comprises:
a capsule wall;
a second solvent within the capsule wall; and
first display particles and second display particles, which are dispersed in the second solvent,
wherein each of the first display particles comprises first electrophoretic particles and a first infrared chromic layer that surrounds the first electrophoretic particles, and
each of the second display particles comprises second electrophoretic particles and a second infrared chromic layer that surrounds the second electrophoretic particles,
wherein the first electrophoretic particles and the second electrophoretic particles are charged with different charges.

12. The reflective display device of claim 11, wherein each of the first infrared chromic layer and the second infrared chromic layer is coated with a substantially uniform thickness.

13. The reflective display device of claim 11, wherein the first electrophoretic particles and the second electrophoretic particles are configured to reflect visible light having different wavelengths.

14. The reflective display device of claim 11, wherein the first infrared chromic layer comprises the same material as the second infrared chromic layer,
wherein a thickness of the second infrared chromic layer is thicker than a thickness of the first infrared chromic layer.

15. The reflective display device of claim 14, wherein the thickness of the second infrared chromic layer is about 1 time to about 1.5 times greater than the thickness of the first infrared chromic layer.

16. The reflective display device of claim 11, wherein the first infrared chromic layer has substantially the same thickness as the second infrared chromic layer,
wherein infrared emissivity of the second infrared chromic layer is greater than infrared emissivity of the first infrared chromic layer.

17. The reflective display device of claim 11, wherein each of the first and second infrared chromic layers is configured to transmit visible light.

18. The reflective display device of claim 11, wherein each of the first and second infrared chromic layers comprises at least one of tungsten oxide (WO₃), nickel oxide (NiO), vanadium oxide (V₂O₅), iridium oxide (IrO₂), polyaniline (PANI), a conductive polymer, or a combination thereof.

19. The reflective display device of claim 11, wherein at least one of the lower electrode and the upper electrode is configured to transmit visible light and infrared rays.

20. A reflective display device comprising:
a first substrate and a second substrate, which are opposite to and spaced apart from each other;
a first pixel configured to reflect infrared rays, and a second pixel configured to reflect visible light, between the first substrate and the second substrate; and
a pixel defining layer configured to separate the first pixel and the second pixel from each other,
wherein the first pixel comprises:
a first lower electrode and a first upper electrode, which are opposite to and spaced apart from each other;
an electrolyte between the first lower electrode and the first upper electrode; and
infrared chromic particles dispersed in the electrolyte, and
wherein the second pixel comprises:
a second lower electrode and a second upper electrode, which are opposite to and spaced apart from each other;
a first solvent between the second lower electrode and the second upper electrode; and
a capsule structure dispersed in the first solvent,
wherein the capsule structure comprises:
a capsule wall;
a second solvent within the capsule wall; and
first electrophoretic particles and second electrophoretic particles, which are dispersed in the second solvent and charged with different charges.
